(19) United States
(12) Patent Application Publication
(10) Pub. No.: US 2024/0380190 A1
(43) Pub. Date: Nov. 14, 2024

(54) PAIR OF TOOL PARTS, METHOD FOR STRIPPING A CABLE, AND METHOD FOR CRIMPING A BLANK

(71) Applicant: GUSTAV KLAUKE GMBH, Remscheid (DE)

(72) Inventors: Egbert FRENKEN, Heinsberg (DE); Andreas LEHR, Neuss (DE)

(73) Assignee: GUSTAV KLAUKE GMBH, Remscheid (DE)

(21) Appl. No.: 18/688,124

(22) PCT Filed: Sep. 2, 2022
(86) PCT No.: PCT/EP2022/074441

§ 371 Date: Feb. 29, 2024

(30) Foreign Application Priority Data
Sep. 3, 2021 (DE) 10 2021 122 853.0

(51) Int. Cl. H02G 1/12

(52) U.S. Cl. CPC H02G 1/1229

(57) ABSTRACT

A pair of tool parts which include a first and a second tool part, can be secured exchangeably in tool jaws of a hand-held tool and can be moved together by means of the tool jaws, for enclosing a cable, encapsulated with an insulating sheath, over a part of a length of the cable. A receiving region of the tool parts formed when moved together, encloses a semi-circular region of the cable in cross section with a longitudinal dimension and a transverse dimension remains for the cable in each tool part. The receiving region is penetrated by a blade and has an inwardly pointing clearance. A plurality of blades are configured in each tool part, and the blade tips run in accordance with a helical line when the tool parts are moved together. Methods for stripping a cable are also provided.

### TECHNICAL FIELD

In first instance, a pair of tool parts comprising a first and a second tool part is described, wherein the tool parts can be mounted exchangeably in tool jaws of a hand-held tool and can be moved together by means of the tool jaws, for enclosing a cable encapsulated with an insulating sheath over a part of a length of the cable, wherein, when tool parts are moved together, a receiving region which encloses a semicircular region of the cable in cross-section and has a longitudinal dimension and a transverse dimension remains for the cable in each tool part, which receiving region is penetrated by a plurality of blades and has an inwardly pointing clearance, wherein, when the tool parts are moved together, blade tips of the blades run in such a manner that they form a helical line.

Furthermore, a pair of tool parts with a first and a second tool part is described, wherein the tool parts can be mounted exchangeably in tool jaws of a hand-held tool and can be moved together by means of the tool jaws, wherein each tool part forms a receiving region delimited by longitudinal blades and transverse blades, for enclosing a cable encapsulated with an insulating sheath over a part of a length of the cable to be stripped, wherein, when the tool parts are moved together, an insulating portion of the cable corresponding to the part of the length is received in each tool part, and the receiving region has a bottom region formed with a longitudinal dimension and a transverse dimension between the longitudinal blades, wherein in a cross-section, a depth dimension of the receiving region is greater than a transverse dimension.

In addition, a method for stripping a cable is described, wherein the cable has a cable core and an insulating sheath, by cutting out one or two insulation portions using a pair of tool parts having a first and a second tool part which can be mounted exchangeably in tool jaws of a hand-held tool and can be moved together by means of the tool jaws, for enclosing the cable encapsulated with the insulation over part of a length of the cable.

Moreover, described is a pair of tool parts having a first tool part and a second tool part which can be mounted and moved together in a hand-held tool, wherein, when tool parts are moved together, a receiving region with a longitudinal dimension and a transverse dimension remains in each tool part for the cable and the tool parts are formed identically to one another.

### PRIOR ART

Tool parts of the type in question, in particular pairs of such tool parts, and methods for stripping a cable are known. By using such tool parts, stripping of a cable can at least be prepared by cutting through the insulating sheath of the cable over a longitudinal portion of the cable by means of the blade at the tool part. The insulating portion separated from the insulating sheath that remains at the cable is then usually removed by hand. Such tool parts are known, for example, from U.S. Pat. No. 10,554,006 B2 or from EP 0 780 943 A1.

In addition, regarding the prior art, reference is also made to JP 2014 204653 A, CN 108 054 622 A, US 2014/182441 A1, CN 101 188 349 A and U.S. Pat. No. 5,085,114 A.

The pairs of tool parts for cutting an insulation sheath can be received in the tool jaws of a preferably hydraulically and/or electrically operated device with tool jaws that can be moved towards one another. The tool parts can be formed integrally with the tool jaws or, as is customary and generally preferred, can be exchangeably received on the tool parts.

### SUMMARY OF THE INVENTION

Based on the prior art described above, the object is to provide a pair of tool parts of the type in question and a method for stripping a cable, by means of which an advantageous cutting result for preparing a stripping of a cable portion can be achieved.

A possible solution to the object is given for a pair of tool parts, in which it is intended that a plurality of blades is formed in each tool part, the blade tips of which run along a helical line when the tool parts are moved together, wherein each tool part further has an exchangeable further blade which is provided at least one end of the receiving region, wherein the tool part has the further blade in the region of an end as viewed in the direction of the longitudinal dimension, wherein the further blade is provided as a boundary at the end of the receiving region and can selectively be fastened at the end, wherein the further blade extends in a direction of the transverse dimension of the receiving region, and wherein the further blade is provided as a separating blade which extends into the cable core and serves to separate the cable.

As a result of the proposed design of the tool parts, an advantageous cutting pattern is produced in the portion of the insulating sheath to be stripped, which cutting pattern allows the insulating portion to be removed in a manner that is particularly favorable in terms of handling. For this purpose, the blades of the two tool parts are provided and designed in such a manner that, when the tool parts are in the state in which they are moved together, they complement each other to form a helical shape that extends circumferentially around a central axis of the receiving region in the direction of the longitudinal dimension of the receiving region, corresponding to a thread with a thread pitch that is preferably constant over the length. In this manner, the individual blades of the tool parts accordingly form a helical continuous blade in the closed position of the tool parts, which leaves a corresponding helical cutting pattern in the insulation portion received in the receiving region.

An insulation portion prepared for cutting in this manner can then preferably be removed by hand, for example by gripping one end of the insulation portion with a tool, further, for example, with pliers, from the cable core to be exposed by unwinding or peeling it off.

A cutting depth in the direction of a transverse dimension of the receiving region can be selected according to the radial thickness of the insulating sheath, so that in the course of cutting into the insulating portion to be removed, the blade tips or the circumferentially extending helical blade tip resulting overall in the closed position completely penetrates through the insulating sheath. Moreover, the cutting depth can also be selected to be slightly less than a dimension of a radial thickness of the insulating sheath, for example corresponding to about 0.8 to 0.95 times the thickness dimension, so that when the cutting process is carried out, the blade tip does not reach the cable core and thus a thin web facing the cable core, which can be easily separated by tearing, remains between the winding portions.

Such tool parts can be used, for example, for insulated cables with a fine-wire cable core, further preferably for cable cores with a predetermined conductor cross-section, for example 70 mm², and a further predetermined outer diameter range of the cable as a whole, so that cables with a predetermined conductor cross-section but with different thicknesses of the insulating sheath can also be processed with the same pair of tool parts. Moreover, such tool parts can be used in a cutting process for both hard and soft insulating sheaths, in particular insulating sheaths made of polyethylene (PE).

More preferably, the blades or the blade tips run along a multi-start helical line. A two-start helical line is preferred. In an assembled view of both tool parts of the pair of tool parts, there are multiple starts, preferably correspondingly two starts, each of which continues in its own helical line. Correspondingly, there are also two or more ends of the helical lines at another end of the tool parts, as viewed in a longitudinal direction of an enclosed cable. The multi-start configuration is associated with the advantage that narrower strips of the insulating sheath are cut, and further, that there is an opposite cut in each case. Removing cut strips of the insulation material can be carried out more advantageously.

According to another idea, one solution to the object for a pair of tool parts is provided in that an ejection means associated with the receiving space is provided to act on a separated insulation portion for detaching from the tool part.

According to another idea, the object can also be achieved in that the blades extending in the longitudinal and/or transverse direction are of multi-part design so that after a cutting process, a connecting web remains between insulating portions or an insulating portion and a continuing part of the insulating sheath.

The object can also be achieved in that in a tool part, a through-opening is provided which, extending from an outer surface of the tool part, opens into the bottom region of the receiving region in order to be able to act on a severed insulating portion by means of a separate pushing element.

In addition, the object can be achieved in that on both tool parts, at least two guide projections are formed, which are spaced apart from one another in accordance with a longitudinal dimension of the receiving region, project in a direction in which they move together, are exposed in an opening position of the tool parts and move into a guide recess of the respective other tool part in the course of the tool parts moving together.

With regard to the method for stripping a cable, according to a first solution, it can be provided that a severed insulation portion is acted upon using an elastic restoring force of the insulation portion itself or of a spring element located in a tool part for ejecting the insulation portion.

According to another solution, the method can be based on the fact that the insulation portion is incompletely separated from a further insulation portion or the remaining insulating sheath, so that the tool part can be removed without carrying along the insulation section, and that the insulating portion is separated out by additional cutting or tearing action.

Due to the cross-sectionally opposite blades, the insulating sheath is preferably completely severed in a longitudinal direction of the cable in regions diametrically opposite the longitudinal axis of the cable, optionally tangent to the region of the cable core, so that substantially dome-like separating portions of the insulating sheath are produced, which, after the tool parts have been moved together and the cutting process has been completed accordingly, are preferably received in collection chambers provided adjacent to the blades. Associated with the receiving regions of each tool part, slug-like or, as a rule, shell-like insulating portions remain, which can become jammed in the respective receiving region in such a manner that they are not or not completely dragged along when the tool parts move back to their spaced-apart home positions. Rather, there is a risk that these insulation portions will remain jammed in the respective receiving region. The removal of such a jammed insulation portion in the receiving region is time-consuming. This circumstance is advantageously counteracted by the solutions described here.

Thus, the insulation section located in the receiving region can be acted on by the ejection part provided in the receiving region in such a manner that any jamming that may occur is overcome and thus detaching from the tool part is achieved. In doing so, the restoring force of the insulating sheath or insulating portion, which is usually made of an elastically restorable plastic material such as polyethylene, can be advantageously utilized.

In the case of a multi-part configuration of the blades and by leaving a connecting web between the insulating portions or between an insulating portion and a continuing part of the insulating sheath, the insulating portions still cohere with each other and/or with the continuing part of the insulating sheath even after the cutting process has been carried out, so that the portion of the cable to be stripped is completely exposed when the tool parts are moved apart. Here too, no insulating portions remain in the tool parts, in particular in the receiving regions. Finally, the insulating portion or the insulating portions are separated from each other and from the remaining insulating sheath by cutting through the initially remaining webs, so that the insulating portions can be removed accordingly to complete the stripping. The webs can be severed by cutting, but preferably by tearing alone.

Alternatively or in combination with one of the solutions described above, a pushing element, for example a pin, furthermore, for example, the tip of a screwdriver or the like, can be passed through the optionally provided through-opening after the cutting process has been carried out, in order to use this pushing element as an ejection means acting correspondingly on the insulating portion located in the receiving space.

As a result of the further preferably provided guide projections on the tool parts, precise alignment of the tool parts and thus of the blades formed on the tool parts can be achieved. The guided alignment is preferably given both in the circumferential direction of the cable to be stripped and in the longitudinal direction so that in the case of, for example, a helical cut extending circumferentially in the insulating wall, there are no offsets or at least no offsets in the course of the cut that impair the removal of the cut-in insulating wall portion.

The solutions described herein are explained below, also in the description of the figures, often in their preferred association with the subject matter of an independent claim or with features of further claims. However, they can also be of importance in association with only individual features of the independent claim and/or one or more of the further independent claims, or independently in each case.

The tool parts for cutting an insulating sheath, as is also preferred, can be received as exchangeable tool parts in tool jaws of a hand-held tool.

Moreover, in each tool part, in particular when the same is designed for cutting an insulating sheath, a further blade can be provided which extends in a direction of the transverse dimension of the receiving region. Such a further blade can further preferably be arranged associated with an end of the tool part as viewed in the direction of the longitudinal dimension, for circumferentially generating a cutting line in the region of an end of the insulating portion to be removed. By using such a further blade, for example, a free end of a cable can be prepared for removal of the insulating portion or portions by corresponding cutting engagement in the insulating sheath.

In the case of a helical course of the cutting line in the region of the insulating portion, unwinding the insulating portion can be carried out after such a cutting process has been carried out, wherein the insulating portion can be removed when the cut produced circumferentially by the further blade is achieved. This results in a circumferentially preferably continuous and uniform cut surface at the end of the now stripped region of the cable.

Moreover, two further blades can be provided on each of the two tool parts so that, viewed in the longitudinal direction, a circumferentially closed cut can be made at the end of the insulating portion. Such an arrangement proves to be advantageous in particular when stripping a middle portion of the cable such that regions of the insulating sheath remain on both sides of the portion to be stripped when viewed in a longitudinal direction of the cable.

According to one solution, the further blades are provided to be exchangeable. Accordingly, a configuration of tool parts and further blades can be selected, optionally adapted to suit the conditions and/or specifications, for example with further blades on one end only, with further blades on both ends, or without any further blades at all.

The further blades can be present in different configurations, for example as stripping blades or as separating blades, for cutting a cable to length in the region of one tool end. At least one further blade is provided as a separating blade, which extends into the cable core and serves to separate the cable.

With regard to an ejection means associated with the receiving region, it can be provided according to a further preferred embodiment that the ejection means is designed as a spring element arranged on the bottom region, which is elastically deformable by a severed insulating portion received in the receiving region. This elastic deformation is achieved in the course of carrying out the cutting process, i.e. in the course of moving the tool parts together, and is accompanied by a pre-tensioning of the spring element. The restoring force of the spring element built up in the process of this causes a corresponding effect on the separated insulating portion to detach it from the tool part as the tool parts move back towards their initial position.

Such a spring element can be a leaf spring, in particular a leaf spring made of spring steel. Moreover, the spring element can also be formed, for example, by a correspondingly arranged leg spring or furthermore, for example, a compression spring, in particular a cylindrical compression spring.

Furthermore, alternatively, the spring element can also be designed as an elastically restorable plastic part. In this respect, for example, an elastomer material, further, for example a rubber material, can be selected to form the spring element.

In this context, an elastically restorable plastic part that has a circular cross-section in an undeformed state proves to be advantageous. For example, a rod-shaped elastically restorable plastic part can act as an ejection means in the bottom region of the receiving region.

According to another solution, it is provided that, in addition to or as an alternative to a spring element, the ejection means is designed as a deformation portion projecting at the bottom region into the inner clearance of the receiving region, which serves for acting on the insulating portion in an elastically deforming manner. Such a deforming portion can be formed, for example, integrally with and optionally also in the same material as the tool part, in particular in the bottom region thereof. In such a configuration, the elastic deformability of the material of the insulating sheath in the region of the insulating portion is used to act on the insulating portion in order to separate it from the tool part. However, the tool-side deformation portion itself is preferably rigid and cannot be deformed in the course of the cutting process.

Alternatively or additionally, the deformation section can be in the form of one or more individually projecting pins, for example in a conical or tapered shape. Additionally or alternatively, one or more rib-shaped projections can also be provided. The rib-shaped projection is preferably triangular in cross-section or preferably formed with a concave, partially or completely curved contour of the outer surface which is intended to interact with the insulating portion. Such a rib-like shape, furthermore, can alternatively or additionally also be provided on only one peripheral edge of the receiving space. In this case, more preferably, in such a manner that only a partial surface of the rib-like projection forms a surface of the receiving space. More preferably in such a manner that the cross-section of the receiving space is beveled at this peripheral edge. When the tool halves move together, this region then presses more strongly on the insulating portion than the remaining ones, so that a stronger restoring force can also result there due to the elasticity of the insulating portion.

In a further configuration, two guide projections of the same tool part can be formed opposite each other with respect to the receiving region. With reference to a view in which a separation or contact plane of the tool parts is represented as a surface, a point-symmetrical arrangement of guide projections and guide recesses can result.

A guide recess can be formed by a (counter) guide projection of the other tool part with respect in any case to at least one of its surfaces.

Each tool part can have three or, as preferred, four guide projections. In the case of four guide projections, these are preferably each associated with a corner region of the tool part.

Furthermore, if four guide projections are provided on each tool part, the guide projections of the same tool part located opposite one another on a narrow side with respect to the receiving space can have an offset in the longitudinal direction in the state in which they are moved together, which offset corresponds in any case to the given thickness in this longitudinal dimension of the retracted (counter) guide projection of the other tool part, wherein a retracted (counter) guide projection is located in each case in the longitudinal dimension on a different side of one tool part. This can result in a nesting of guide projections, which ensures precise alignment of the tool parts to each other, both in the longitudinal and circumferential direction.

### BRIEF DESCRIPTION OF THE DRAWINGS

In the following, the solutions described herein are explained with reference to the attached drawing, which, however, only represents exemplary embodiments. A part that is only explained in relation to one of the exemplary embodiments and is not replaced by another part in a further embodiment example due to the special feature highlighted there is thus also described for this further exemplary embodiment as a possible existing part in any case. In the drawing:

FIG. 1 shows a perspective view of a hand-held tool with a pair of tool parts arranged in tool jaws, relating to a first embodiment with a plurality of blades;

FIG. 2 shows the enlargement of the area II in FIG. 1;

FIG. 3 shows the pair of tool parts of the first embodiment in a perspective view;

FIG. 4 shows the pair of tool parts of the first embodiment in an exploded perspective view;

FIG. 4a shows a perspective view of a pair of further blades;

FIG. 4b shows the further blades of FIG. 4 in a further configuration;

FIG. 4c shows the further blades of FIG. 4a in a further configuration;

FIG. 5 shows a view from the front against the pair of tool parts according to arrow V in FIG. 3;

FIG. 6 shows a sectional view along line VI-VI in FIG. 5, representing an open position of the tool parts;

FIG. 7 shows a sectional view corresponding to FIG. 6, relating to an alternative configuration with a further blade;

FIG. 8 shows a further sectional view corresponding to FIG. 6, relating to an alternative configuration with two further blades;

FIG. 9 shows a view from the front according to arrow IX in FIG. 8;

FIG. 10 shows a view from the front corresponding to FIG. 9, but relating to a position in which the tool parts of the first embodiment are moved together;

FIG. 11 shows a sectional view according to FIG. 8, relating to the position when moved together according to FIG. 10;

FIG. 12 shows a perspective view of a cable to be partially stripped after carrying out a cutting process using the tool parts of the first embodiment;

FIG. 13 shows a perspective view of the cable in the course of a stripping process, corresponding to FIG. 12;

FIG. 14 shows a perspective view of a pair of tool parts of a second embodiment;

FIG. 14a shows an exploded view corresponding to FIG. 14, relating to an alternative embodiment;

FIG. 15 shows a section according to line XV-XV in FIG. 14, relating to the tool parts in an open position with a cable to be stripped arranged between the tool parts;

FIG. 16 shows a sectional view according to FIG. 15, relating to the position in which the tool parts of the second embodiment are moved together;

FIG. 17 shows the section along the line XVII-XVII in FIG. 16;

FIG. 18 shows a subsequent illustration of FIG. 16 after the tool parts of the second embodiment have been displaced back into the open position;

FIG. 19 shows a perspective illustration of the situation according to FIG. 18;

FIG. 20 shows a sectional view according to FIG. 16, relating to a third embodiment;

FIG. 21 shows a sectional view according to FIG. 18, relating to the embodiment according to FIG. 20;

FIG. 22 shows a perspective view of the situation according to FIG. 21;

FIG. 23 shows another sectional view according to FIG. 16, relating to a fourth embodiment;

FIG. 24 shows the section along the line XXIV-XXIV in FIG. 23;

FIG. 25 shows a sectional view corresponding to FIG. 18, relating to the embodiment according to FIG. 23;

FIG. 26 shows a sectional view according to FIG. 24, relating to the situation according to FIG. 25;

FIG. 27 shows a perspective illustration of a pair of tool parts in a fifth embodiment with a cable to be stripped, after the tool parts have been displaced back into the open position;

FIG. 28 shows a perspective view of the region of the cable prepared for complete stripping using the tool parts of the fifth embodiment;

FIG. 29 shows a cross-section through the prepared stripping region of the cable;

FIG. 30 shows a perspective view of a tool part in a further embodiment; and

FIG. 31 shows a view according to arrow XXXI in FIG. 30.

### DESCRIPTION OF THE EMBODIMENTS

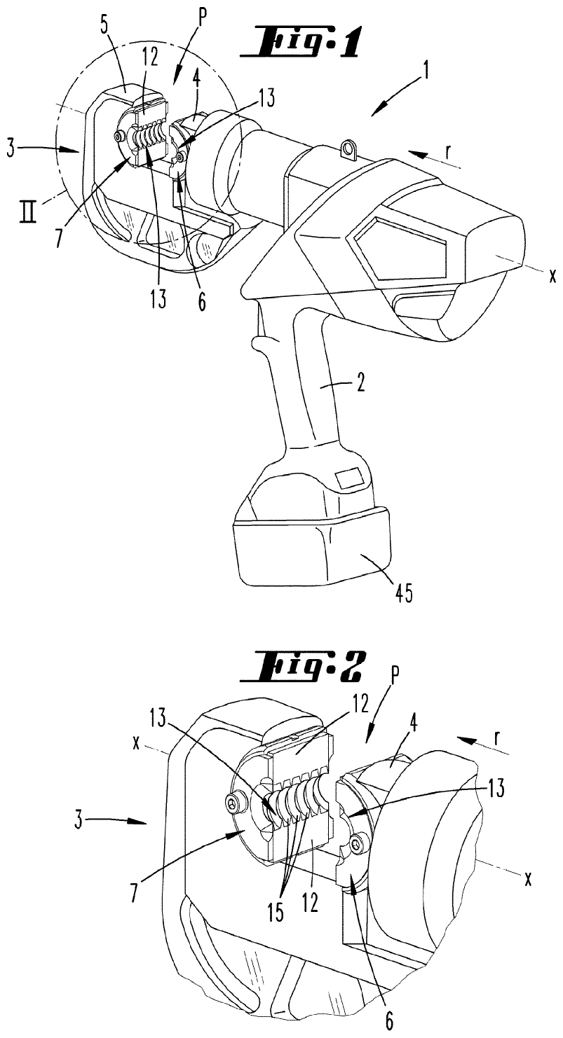

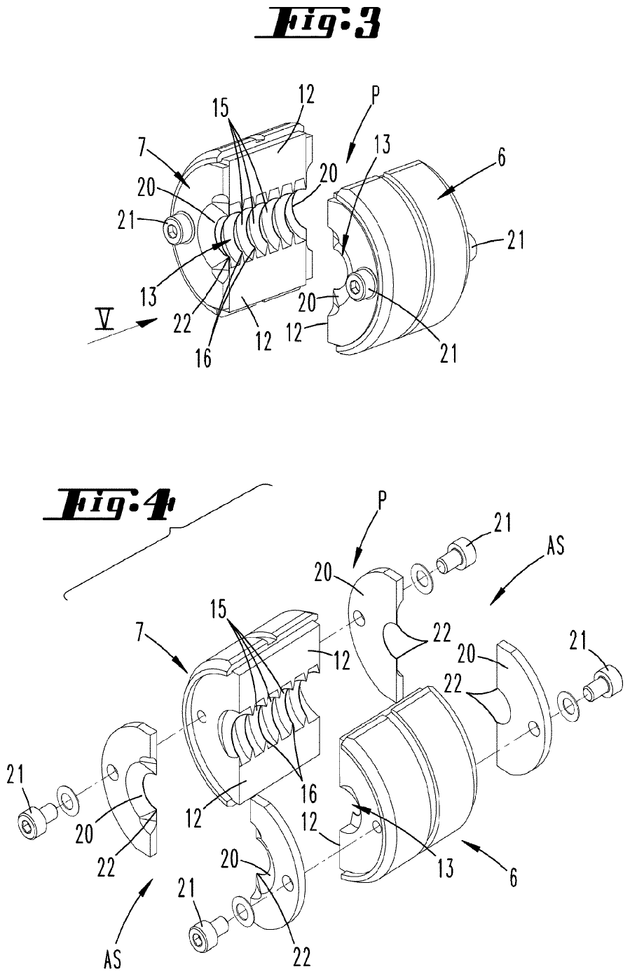

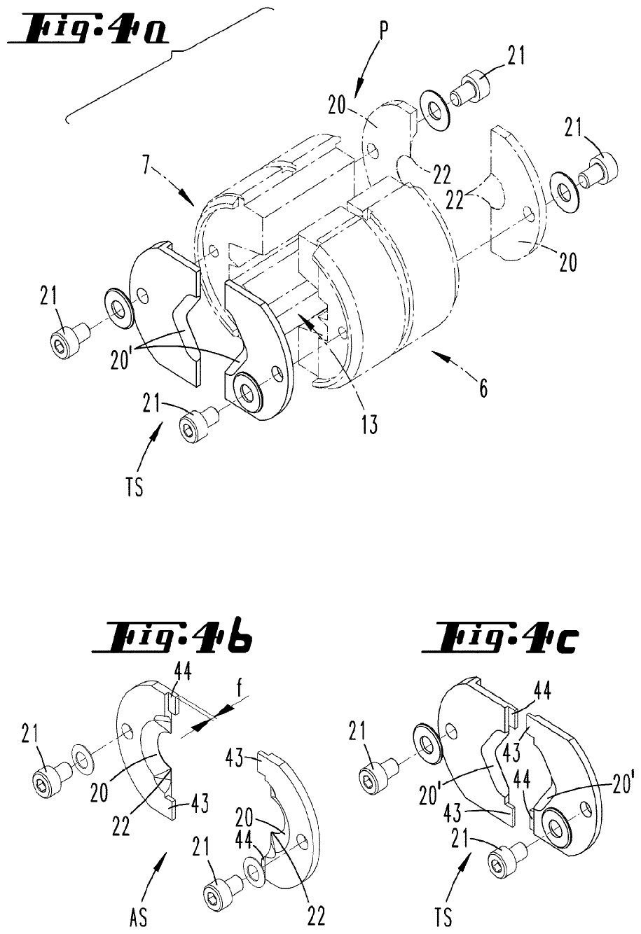

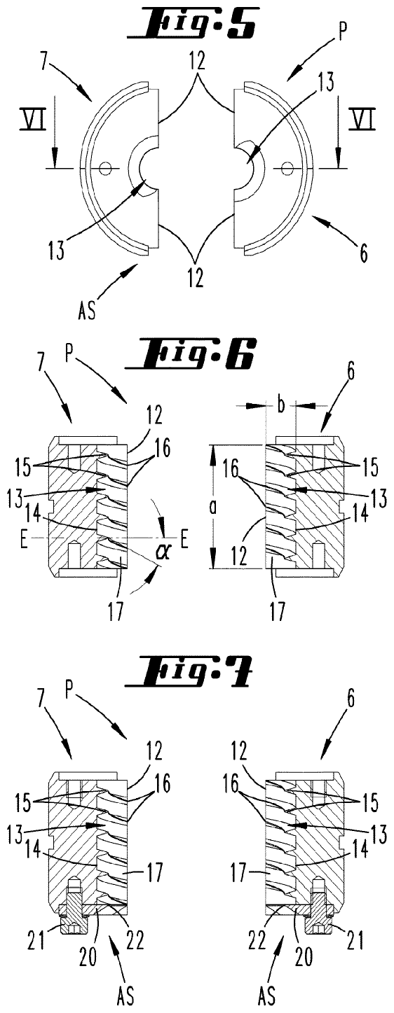

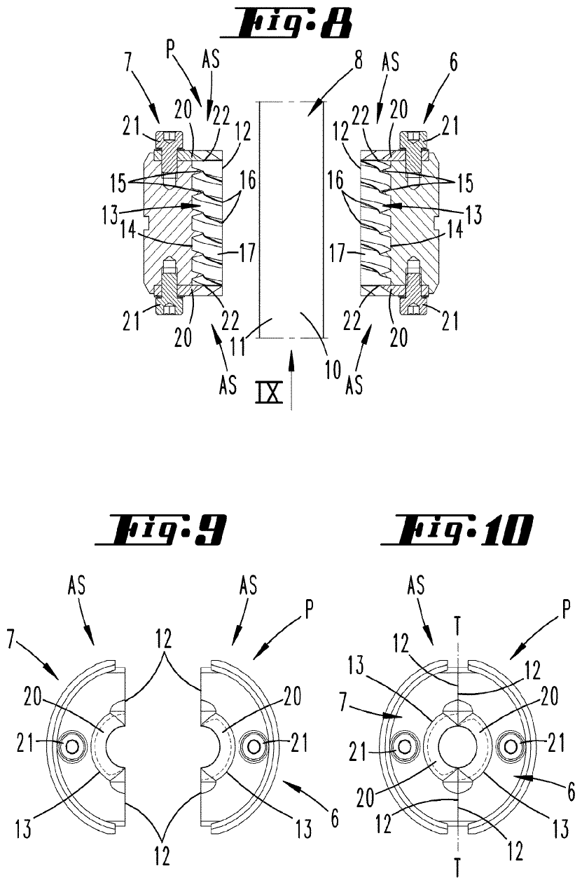

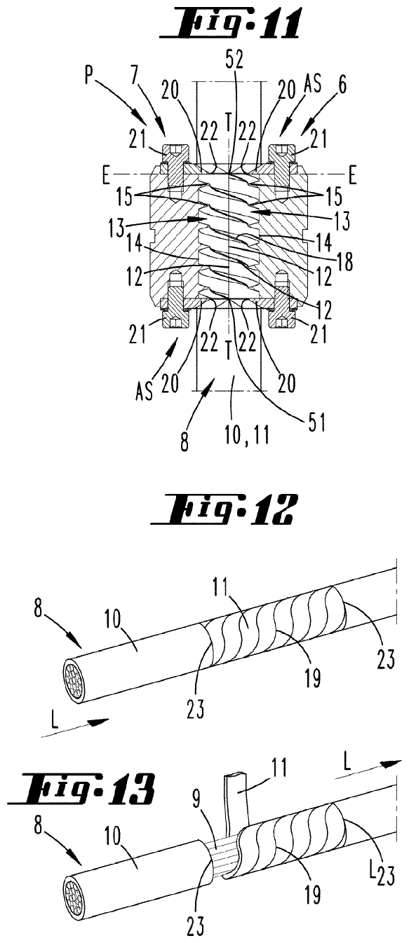

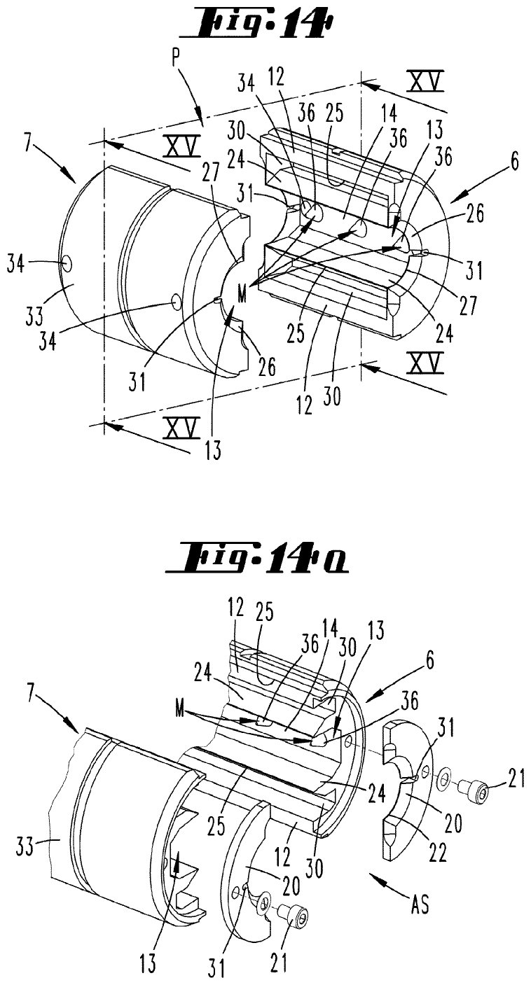

Shown and described, in first instance with reference to FIG. 1, is a hand-held tool 1, which is designed here in the form of a pistol-like drive device part with a handle region 2 and a working head 3.

Alternatively, the hand-held tool 1 can also be designed as a substantially rod-shaped drive device part.

Such drive device parts or hand-held tools 1 are known, for example, from WO 2008/138987 A2 (U.S. Pat. No. 8,056,473 B2) or also from WO 2003/084719 A2 (U.S. Pat. No. 7,254,982 B2). The hand-held tool 1 can alternatively have an electromotive spindle drive. Such a hand-held tool 1 is known, for example, from WO 2014/009363 A1 (U.S. Pat. No. 10,468,847 B2). The content of these WO publications or US publications is hereby included in full in the disclosure of the solutions described herein, including for the purpose of incorporating features of these WO publications or US publications in claims of the present documents.

Two tool jaws which can be moved linearly towards one another are arranged in the working head 3, wherein during operation of the hand-held tool 1, a movable tool jaw 4 can preferably be displaced linearly along an axis x in the displacement direction r, see FIG. 1, towards a preferably stationary tool jaw 5. The drive is preferably electro-hydraulically powered, for which purpose an accumulator 45 can also be provided, for example at the end of the handle region 2, which can also be used to supply electricity, for example to a hydraulic medium pump and a control unit.

The tool jaws 4 and 5 are carriers of preferably exchangeable tool parts 6 and 7, wherein a screw or latch fixing of the tool parts 6 and 7 can be provided in the associated tool jaws 4 and 5, for removing the tool parts 6 and 7 from the tool jaws 4 and 5 or for exchanging the tool parts 6, 7.

The tool parts 6 and 7 of such a pair P, as is also preferred, can have substantially the same design, so that a fixed association of a tool part with a specific tool jaw is not mandatory in the case of exchangeable tool parts 6, 7.

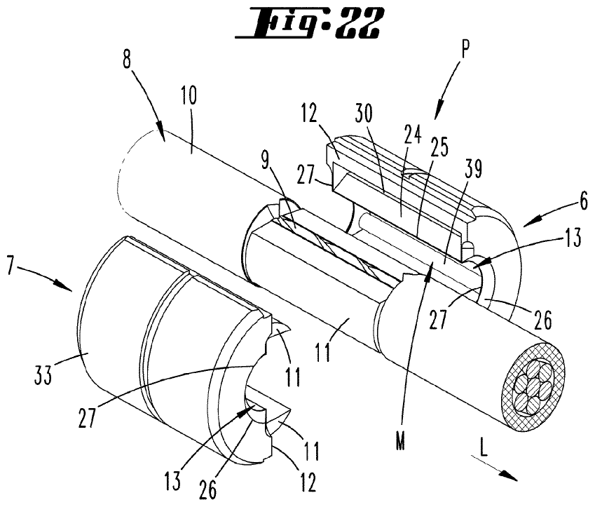

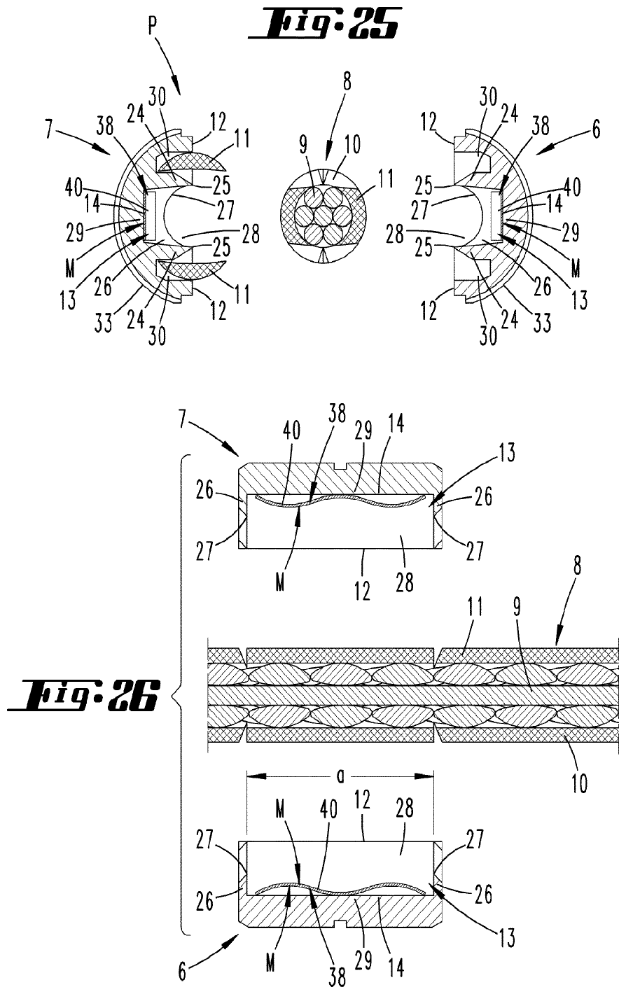

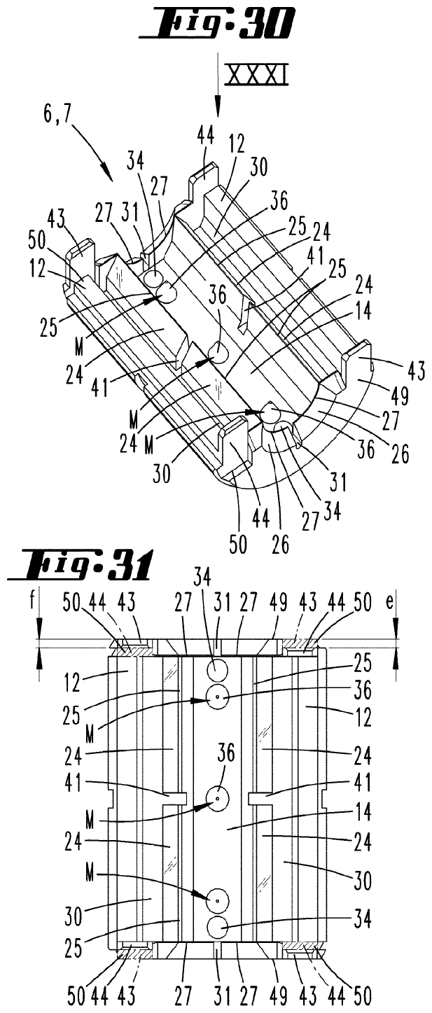

The tool parts 6 and 7 of the embodiments shown in FIGS. 1 to 30 are formed for stripping or for preparing the stripping of a cable 8. Such a cable 8, with reference, for example, to FIG. 12, usually has a cable core 9 with preferably a plurality of strands and an insulating sheath 10 enclosing the cable core 9. In order to be able to establish an electrically conductive connection of the cable 8, the cable core 9 must first be exposed in the corresponding portion of the cable 8 by removing an insulating portion 11 of the insulating sheath 10.

The tool parts 6 and 7 of the embodiments shown in FIGS. 1 to 30 are designed to prepare for an ultimately complete removal of the aforementioned insulating portion 11 by cutting in and/or through the insulating sheath 10 over a predetermined partial length of the cable 8 enclosed by the tool parts 6 and 7.

In a section viewed transverse to a longitudinal extent of a cable 8 guided between the tool parts 6 and 7 in preparation for stripping, each tool part 6 and 7 initially has a receiving region 13 by means of which each tool part 6, 7 encloses the cable 8 in a substantially semicircular manner when the tool parts 6 and 7 are moved together. Accordingly, the two receiving regions 13 of the tool parts 6 and 7 preferably complement each other in the state in which the tool parts 6 and 7 are moved together to form an overall substantially circular-cylindrical receptacle for the cable 8. In the position in which the tool parts 6 and 7 are moved together, parting surfaces 12 of the tool parts 6 and 7 facing each other, as is also preferred, can rest against each other in a parting plane T.

Furthermore, a receiving region 13 of a tool part 6, 7 has a longitudinal dimension a pointing in its longitudinal direction when the cable 8 is inserted and, viewed transversely thereto, a transverse dimension b, correspondingly in the radial direction when the cable 8 is inserted. The longitudinal dimension a preferably corresponds to a multiple of the transverse dimension b, for example, as can also be seen from FIG. 6, approximately 4 to 5 times the transverse dimension b.

The receiving region 13 forms a receiving region bottom 14, on which a plurality of blades 15 are formed pointing in the direction of the transverse dimension b. These blades 15 are preferably formed integrally with and in the same material as the tool parts 6 and 7, respectively, further in particular with the receiving bottom 14.

Viewed over the longitudinal dimension a, for example, four to eight such blades 15 can be provided. FIGS. 1 to 12 of the first embodiment each show six such blades 15, which are preferably evenly spaced apart from one another when viewed over the longitudinal dimension a.

The blade tips 16, which point radially inwards and correspondingly towards each other with respect to the position in which the tool parts 6 and 7 are moved together, leave a radially inner clearance 17 in this state in which the tool parts are moved together, the diameter of which, in the state in which the tool parts 6 and 7 are moved together, viewed in the direction of the transverse dimension b, is preferably adapted to the diameter of the cable core 9 of the cable 8 to be stripped. Accordingly, in the state in which the tool parts 6 and 7 are moved together, the blades 15 can cut through the insulating sheath 10 over the extent of the longitudinal dimension a, to a depth at which the blade tips 16 come into contact with the circumference of the cable core 9 without damaging the cable core 9 or the strands running through it.

With reference to a longitudinal section, for example according to FIG. 6, the individual blades 15 of each tool part 6, 7 extend at an acute angle α of, for example, about 5 to 15 degrees, further, for example, about 10 degrees to a transverse plane E extending in the direction of the transverse dimension b, namely in helical portions in each case, in such a manner that when tool parts 6 and 7 are moved together, for example according to the illustration in FIG. 11, the blades 15 of both tool parts 6 and 7 complement each other to form a helical blade extending over the entire longitudinal dimension a. Accordingly, the blade tips 16 of the tool parts 6 and 7 that are moved together preferably extend crossing the parting surfaces 12 without a step in the manner of a helical line 18 (see FIG. 11). The helical line 18 preferably runs in an imaginary cylindrical surface.

More preferably, the blades 15 are formed in such a manner that, when the two tool parts 6, 7 are viewed together, a multi-start helical line results, corresponding to a multi-start thread. In the combined view, there are therefore multiple, preferably two starts 51 and ends 52 of the helical line, compare, for example, FIG. 11. Each helical line runs independently of the other from a start 51 to an end 52.

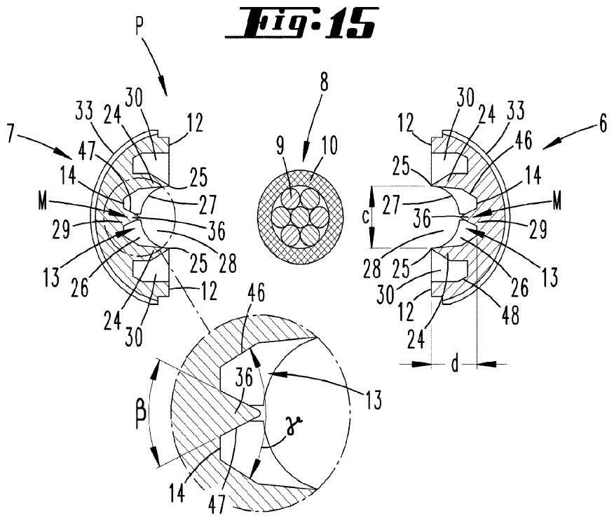

With the cable 8 inserted between the tool parts 6 and 7 and after the tool parts 6 and 7 have been moved together and subsequently returned to their starting position, a helical line 19 corresponding to the helical line 18 of the blade tips 16 and running in the longitudinal direction L of the cable 8 can be seen on the insulating sheath 10, see for example FIGS. 12, 13. This further results in a cut-out helical insulating portion 11 extending over the longitudinal dimension a of the receiving regions 13, which can be removed to expose the cable core 9. In the case of the helical cutting lines 19 shown, it is apparent that the already mentioned multiple helical lines 18 of the blade tips 16 are implemented. This results in advantageous narrow insulating portions 11.

As a result of the proposed design of the tool parts, an advantageous cutting pattern is produced in the portion of the insulating sheath to be stripped, which cutting pattern allows the insulating portion to be removed in a manner that is particularly favorable in terms of handling.

In the state when the tool parts are moved together, the blades complementing each other to form a helical shape extending circumferentially around the central axis of the receiving region in the direction of the longitudinal dimension of the receiving region can thus correspond to a thread with a thread pitch that is preferably constant over the length. This results in the aforementioned helical cutting pattern.

A cutting depth in the direction of a transverse dimension of the receiving region can be selected according to the radial thickness of the insulating sheath, so that in the course of cutting into the insulating portion to be removed, the blade tips or the blade tip circumferentially extending overall in a helical manner as a result of the closed position completely penetrates the insulating sheath. In addition, however, the cutting depth can also be selected to be slightly less than a dimension of a radial thickness of the insulating sheath, for example corresponding to approximately 0.8 to 0.95 times the thickness dimension, so that when the cutting process is carried out, the blade tip does not reach the cable core and thus a thin web, which faces the cable core and can be easily separated by tearing, remains between the winding sections.

The cable with the insulating sheath can have, for example, a fine-wire cable core. The cable core can be provided with a predetermined conductor cross-section, for example 70 mm², and further with a predetermined outer diameter range of the cable as a whole, so that cables with a predetermined conductor cross-section, for example 70 mm², and the cable as a whole can also be provided with a predetermined outer diameter range, so that cables with a predetermined cross-section of the cable core, for example 70 mm², and a further predetermined outer diameter range of the cable as a whole can be provided with different outer diameters with regard to the outer diameter range, i.e. with different thicknesses of the insulation sheath, i.e. with different thicknesses of the insulating sheath, can also be processed with the same pair of tool parts.

Furthermore, by means of such tool parts, the cutting of both hard and soft insulating sheaths is possible, in particular such insulating sheaths made of polyethylene (PE).

In order to further define the region to be stripped, more preferably also in the axial direction of the cable 8, furthermore, cutting into the insulating sheath 10 in the circumferential direction can be provided. For this purpose, each tool part 6, 7 can have a further blade 20 in the region of an end viewed in the direction of the longitudinal dimension a. According to the embodiment shown, this further blade 20 can optionally be fastened at the end, for example via a screw 21, or, as shown in FIG. 14, for example in a further embodiment, be formed directly on the tool parts 6 and 7.

The further blades 20 of the tool parts 6 and 7 are formed and arranged in such a manner that their blade tips 22 extend in a common transverse plane E in the position in which the tool parts 6 and 7 are moved together, so that when a cable 8 is inserted in the position in which the tool parts are moved together, a complete circumferential cutting line 23 is created at the end of the helical cutting line 19 in the insulating sheath 10 in the embodiment of FIGS. 1 to 13 (compare FIGS. 12 and 13).

The blade tips 22 of the further blades 20 preferably run in the same circumferential plane as the blade tips 16 of the blades 15, so that accordingly these blade tips 22 of the further blades 20 also cut into the insulating sheath 10 at most to such an extent that the cable core 9 is not damaged.

For stripping a free end of a cable 8, for example, such a further blade 20 can be provided in each case as stripping blade AS only on one side as a boundary at the end of the receiving region 13 of the tool parts 6 and 7, more preferably also at the end of such a tool part 6, 7 itself. For stripping a portion centered in the longitudinal direction L of the cable 8, thus, a cable portion to which further cable portions having an insulating sheath 10 are connected on both sides in the longitudinal direction L, such further blades 20 are preferably arranged on both sides at the end of the receiving region 13 or the tool parts 6 and 7 (see, for example, FIG. 8), so that when the tool parts 6 and 7 are moved together, cutting lines 23 extending over the circumference are produced on each end of the helical cutting line 19 in the insulating sheath 10. This now further results in an insulating portion 11 that is also exposed at each end by a free cut, which insulating portion can be unwound by gripping one end to expose the cable core 9 as shown in FIG. 13.

As a further alternative, the further blades can also be designed to severe and thus cut the cable 8 to length in the course of preparation. For example, at one end of the tool parts 6 and 7 further blades 20 (stripping blades AS) of the previously described configuration can be provided, by means of which an axial boundary of the portion to be stripped is provided, and at the other end, further blades 20′ can be arranged as separating blades TS as shown in FIG. 4a, the cutting edges of which slide past each other in a scissor-like manner in the state when the tool parts 6 and 7 are moved together, for severing the cable 8 along a circumferential cutting line.

In a further configuration, the further blades 20 and 20′ can preferably be provided as a set, optionally together with a plurality of tool parts 6 and 7 which are substantially designed differently with respect to the shape of the blades, so that a corresponding combination of tool parts 6, 7 and further blades 20 or 20′ can be made on site depending on the circumstances.

In the further embodiments shown in FIGS. 14 to 30, the respective receiving region 13 is delimited in the direction of the longitudinal dimension a by longitudinal blades 24, the blade tips 25 of which preferably extend in the plane T of the parting surfaces 12, so that in the position in which the tool parts are moved together, the blade tips 25 of the tool part 6 preferably touch the blade tips 25 of the other tool part 7.

At each end of the longitudinal extent of the longitudinal blades 24, transverse blades 26 are formed on each tool part 6, 7, wherein the blade tips 27 thereof leave a radially inner clearance 28, preferably adapted to the diameter of the cable core 9 of the cable 8 to be stripped, when the tool parts 6 and 7 are in in the state in which they are moved together.

The transverse blades 26, which in one possible configuration can also be formed as separating blades in the region of an end of the tool parts 6 and 7, and the longitudinal blades 24 delimit a receiving region 13 in the respective tool part 6, 7 with a bottom region 29 facing away from the parting surface 12, which has a longitudinal dimension a corresponding to the spacing of the transverse blades 26 from one another, and a transverse dimension c corresponding to the spacing of the longitudinal blades 24 from one another, and a depth dimension d viewed perpendicular to the transverse dimension c.

According to the alternative embodiment shown in FIG. 14a, the transverse blades 26 can also be provided as exchangeable further blades 20. In this case, for example, further blades 20′ can also be arranged in the form of separating blades TS.

The transverse dimension c, in particular between the blade tips 25 of the longitudinal blades 24, is preferably adapted to the outer diameter of the cable core 9 of the cable 8 to be stripped or to be prepared for removal of an insulating portion. The depth dimension d preferably corresponds to at least the outer radius of the insulating sheath 10 of the cable 8.

In each case on the side of a longitudinal blade 24 facing away from the receiving region 13, more preferably, a collection chamber 30 is formed that is open towards the parting surface 12, as is the receiving region 13.

When tool parts 6 and 7 formed in this manner are moved together, the transverse blades 26 cut the insulating sheath 10 at a distance of the longitudinal dimension a in the circumferential direction, and the longitudinal blades 24 cut through the insulating sheath 10 with their blade tips 25 along a chord of a circle-viewed in cross-section-in such a manner that, with respect to the cable cross-section, diametrically opposite circular segment-like or dome-like insulating portions 11 are created, which are received in the collection chambers 30 when the tool parts 6 and 7 are in the state in which they are moved together (see, for example, FIG. 16).

Such an arrangement with the aforementioned transverse blades is in particular also advantageous if-only-one central section of the insulation of the cable is to be removed, wherein regions of the insulating sheath remain on both sides, as seen in a longitudinal direction of the cable.

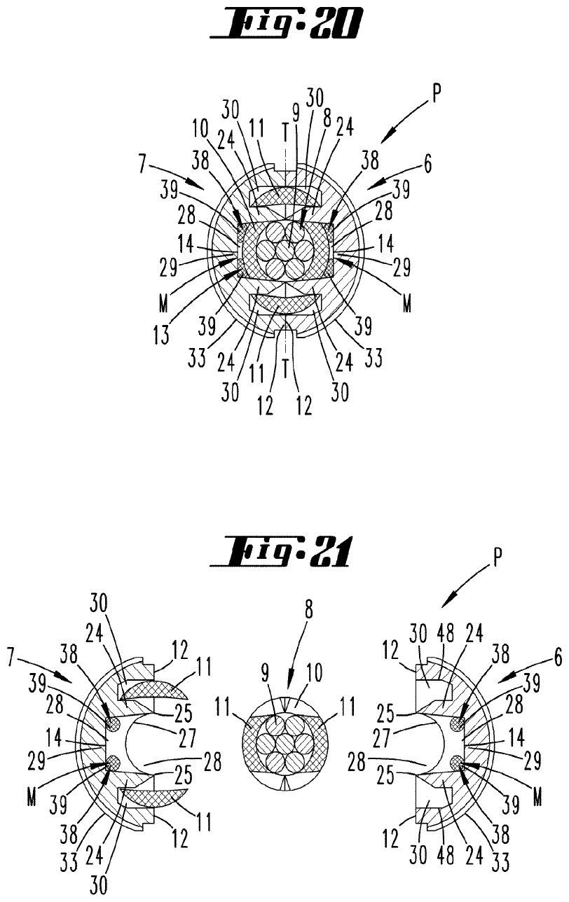

Furthermore, the transverse blades 26 can be formed in multiple parts when viewed over the circumference. Thus, for example, a gap 31 can be provided on the circumference of each transverse blade 26, for example approximately in the middle of its circumferential extent, so that after a cutting process, a connecting web 32 can remain between the insulating portions 11 received in the receiving regions 13 in the cutting position and the continuing part of the insulating sheath 10 (compare, for example, FIG. 19).

After moving the tool parts 6 and 7 apart in the direction of their home position after a cutting process has been carried out, the portion of the cable 8 to be stripped is exposed, with the cut insulating portions 11 remaining clamped in one of the collection chambers 30, if necessary. The cable core 9 is exposed over a section of the insulating sheath 10 corresponding to the length dimension a in diametrically opposite regions. The other insulating portions 11 extending in the receiving regions 13 during the cutting process can then be removed manually or with the aid of a hand-held tool, for example pliers, by cutting through the connecting webs 32.

The ejection, in particular of the slug-like insulating portion 11 received in the receiving region 13 during the cutting process, which is formed in cross-section, for example, like a disc with a convex outer surface, or in cross-section, for example, like a crescent, from the receiving region 13 after the cutting process, is supported, according to the embodiments in FIGS. 14 to 30, by various measures, which can be implemented individually or also in various combinations.

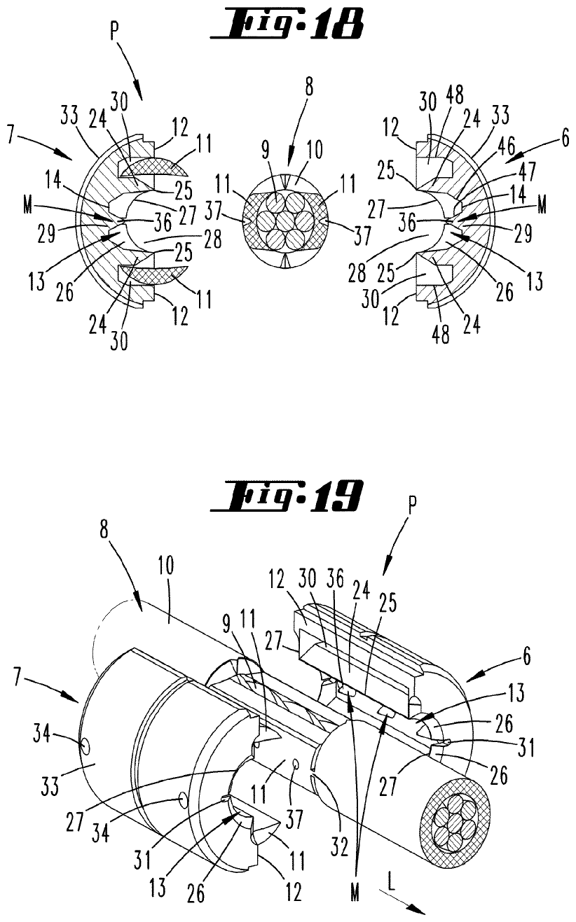

Thus, as shown by way of example in FIG. 17, a through-opening 34 extending from the bottom region 29 of the receiving region 13 can initially open into an outer surface 33. This can be provided, as also shown by way of example in FIG. 17, in each case on the end side of the receiving regions 13 as viewed in their longitudinal dimension a.

Through this through-opening 34, it is possible to act on the severed insulating portion 11 located in the receiving region 13 with the aid of a separate pushing element 35 forming an ejection means M, for example by means of a pin or a screwdriver, and to eject it from the receiving region 13.

Such through-openings 34 for the passage of a pushing element 35 can also be provided in combination with one of the measures listed further below.

According to the embodiment shown in FIGS. 14 to 19, a permanently installed ejection means M can be provided on the bottom side, i.e. associated with the bottom region 29, for the corresponding ejection action on the slug-like insulating portion 11 located in the receiving region 13. Such an ejection means M can further be formed, as also shown, as a deformation section 36 projecting from the bottom region 29 into the inner clearance 17 of the receiving region 13 and further preferably formed integrally with the material of the bottom region 29. Illustrated is a conical or cone-like deformation section 36, the cone or cone tip of which points in the direction of the clearance 17. More preferably, when viewed over the longitudinal dimension a, multiple, for example three, such deformation sections 36 are provided in a line-like arrangement, evenly spaced apart from one another, in each case associated with a receiving region 13 (compare for example FIG. 14).

By means of these deformation portions 36 or ejection means M, the insulating portion 11 extending in the receiving region 13 is acted upon during the cutting process when the tool parts 6 and 7 are moved together in such a manner that an elastic deformation of the same results in the regions loaded by the deformation portions 36 (compare FIGS. 16 and 17). The elastic deformation of the insulating portion occurs in particular if a corresponding elastic insulating material is used, such as elastic plastics, for example polyethylene.

When the tool parts 6 and 7 are moved back in the direction of their initial position, the insulating portion 11 received in the receiving region 13 can push itself away from the deformation portion 36 and thus from the receiving region 13 as a whole by its own restoring force and thus detach itself from the facing tool part (compare FIG. 18). Furthermore, it could occur that the material of the insulating portion 11 does not have the ability to fully recover in the region of the deformation. Indentations 37 previously associated with the deformation portions 36 may remain, but these preferably do not result in a severing of the insulating portion 11 in the respective region.

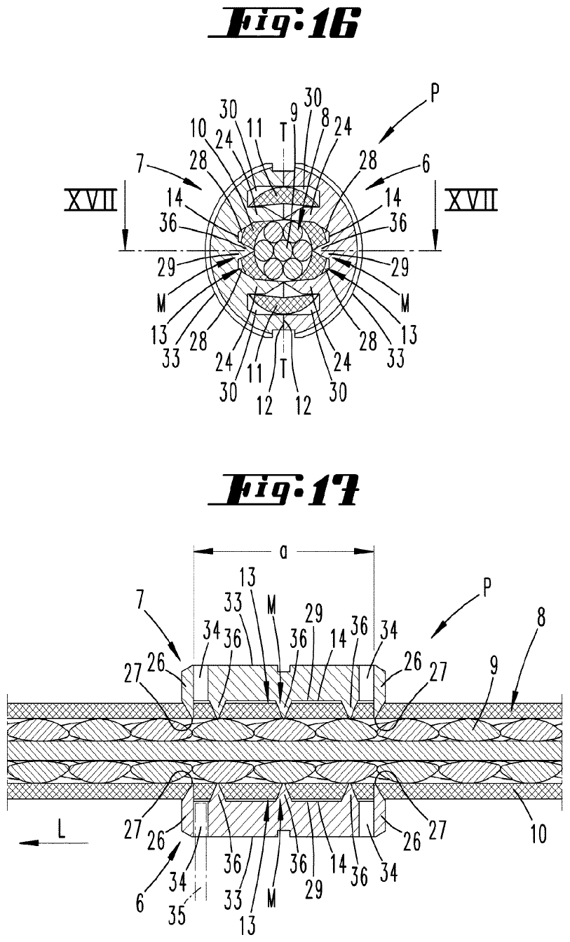

The deformation portions 36 which, in a cross-section through the tool part 6 or 7 or, for example, according to the illustration in FIG. 15, are conical or frustoconical, can have flanks 47 in the cross-section, which can form an angle β of about 30 to 60 degrees between each other, more preferably about 50 degrees.

Such pushing of the insulating portion 11 out of the receiving region 13 can also be supported by obliquely extending peripheral edges 46 of the receiving region 13. These peripheral edges 46 extend with respect to a cross-section through the tool part 6 or 7, for example according to the illustration in FIG. 15, preferably extending from the receiving region bottom 14 in a funnel-like manner away from each other and pointing towards the parting surface 12, wherein the peripheral edges 46 in such a cross-section can form an acute angle γ of about 45 to 75 degrees between each other, more preferably about 60 degrees.

In the course of the tool parts 6 and 7 moving together, there are stronger regions of action on the insulating portion 11 in the region of the obliquely extending peripheral edges 46, as well as in the region of the obliquely extending flanks 47 of the deformation portions 36, than in the remaining regions of the receiving region 13, so that the restoring force can also result there in particular due to the elasticity of the insulating portion 11.

Moreover, inclined flanks 48, for example corresponding to the obliquely extending peripheral edges 46 of the bottom region 13, can also be formed in the bottom region of the collection chambers 30, via which a restoring force can possibly result in the slug-like insulating portion 11 received in the collection chamber 30.

A pretensioning of the spring elements can occur automatically, as it were, in the course of the tool parts moving together.

A spring element can also be formed as a torsion spring or a compression spring, in particular a cylindrical compression spring.

According to the illustrations in FIGS. 20 to 22, according to a further embodiment, ejection means M in the form of spring elements 38 can be provided in each case associated with the bottom region 29 of a receiving region 13. Furthermore, in this case, two such spring elements 38 can be associated with a bottom region 29, which, more preferably, can be formed as elastically restorable plastic parts 39 which are circular in cross-section without deformation. Thus, these spring elements 38 can also be formed as elongated rod-shaped rubber or elastomer elements.

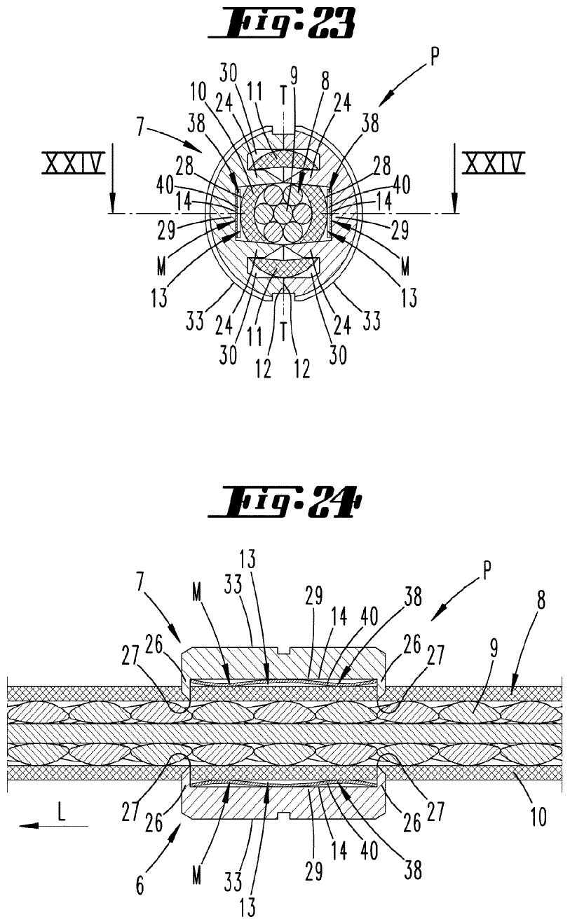

FIGS. 23 to 26 show an embodiment in which such a spring element 38 is formed as a leaf spring 40. In this case, it is preferably a steel spring, which preferably extends in each case over the at least approximately entire surface of extent of the bottom region 29 in the direction of its longitudinal dimension a and transverse dimension b.

When the tool parts 6 and 7 are moved together with the cable 8 inserted between them, the spring element 38 received in the receiving region 13 is elastically deformed as a result of being acted on via the insulating portion 11 received in the receiving region 13, thus generating a spring restoring force which, when the tool parts 6 and 7 are moving back towards their home position, causes the insulating portion 11 to be ejected from the receiving region 13 and thus to be detached from the associated tool part 6, 7.

One or more rib-shaped projections can also be provided. The rib-shaped projection is preferably triangular in cross-section or preferably formed with a concave, partially or overall curved contour of the outer surface intended for interaction with the insulating portion. Alternatively or additionally, such a rib-like design can also be provided on only one peripheral edge of the receiving space. In this case, more preferably in such a manner that, as it were, only a partial surface of the rib-like projection forms a surface of the receiving space. More preferably in such a manner that the cross-section of the receiving space is beveled at this peripheral edge. When the tool halves move together, this region then presses more strongly on the insulating portion than the remaining ones, so that a stronger restoring force can also result there due to the elasticity of the insulating portion.

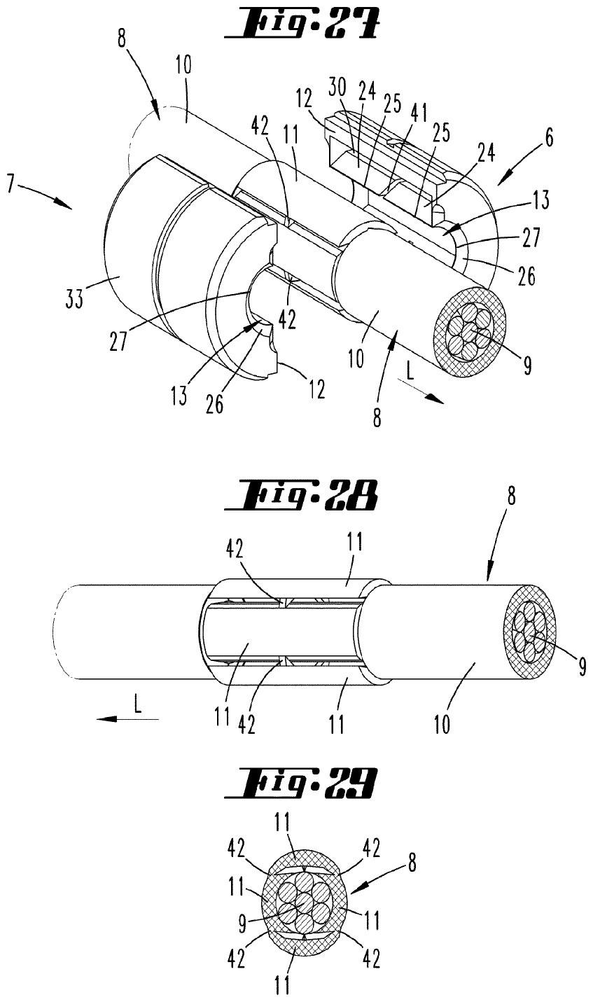

Like the transverse blades 26 described, for example, on the basis of the embodiment according to FIG. 14, which are of a multi-part design in the circumferential direction, the longitudinal blades 24, as shown on the basis of the embodiment in FIGS. 27 to 29, can be designed, in combination with or as an alternative thereto, in multiple parts, viewed in their longitudinal extent, leaving a gap 41 between them accordingly. This results, after a cutting process as described above has been carried out, in a remaining connection of the otherwise dome-shaped severed insulating portions 11 with the further insulating portions 11 received in the receiving regions 13 during the cutting process via remaining connecting webs 42. In the case of a circumferential cutting line 23 circumferentially complete on both sides according to the embodiment in FIGS. 27 to 29, brought about by the transverse blades 26, the insulating portions 11 connected to one another in the region of the cable 8 to be stripped via the connecting webs 42 remain held on the cable 8, so that accordingly the insulating portions 11 facing the receiving regions 13 can be detached from the tool part solely by this connection to one another.

By severing the connecting webs 42 between the insulating portions 11, optionally also by severing any connecting webs 32 between one or more insulating portions 11 and the adjacent, continuing part of the insulating sheath 10, the insulating portions 11 can be removed to expose the cable core 9 over the desired part of the length of the cable 8.

As further shown in the illustration of FIG. 30, viewed in the longitudinal direction of a tool part, guide projections 43 can be formed on one of the tool parts 6 or 7 on the end face, radially outside the transverse blades 26 and projecting beyond the parting surfaces 12, for guiding and centering interaction with counter-guide projections 44 formed on the other tool part 7 or 6 in the course of moving the tool parts 6 and 7 together. In this manner, as is also preferred, it is in particular possible to achieve an alignment of the transverse blades 26 of both tool parts 6 and 7 with respect to one another in the cutting position, which allows a preferred completely circumferential formation of the circumferential cutting line 23.

The guide projections 43 and counter-guide projections 44 preferably have flat surfaces which slide along each other and point towards each other in the course of the tool parts 6 and 7 moving together, wherein guide projections 43 can be provided on diagonally opposite corner regions of the guide surfaces 12 on a tool part 6 or 7 and the counter-guide projections 44 can be provided on the two other corner regions.

Furthermore, in relation to a longitudinal extent in the direction of the longitudinal dimension a of the receiving region 13 or of the longitudinal blades 24 in the direction of this longitudinal extent, the counter-guide projections 44 can be arranged offset inwards with respect to the further guide projections 43, preferably by an offset dimension e which corresponds substantially to the thickness dimension f of the assignable guide projection 43 viewed in this direction. The surface of the guide projection 43 pointing outwards in the aforementioned longitudinal direction can extend in the plane of the associated tool part end face 49 (compare FIGS. 30 and 31).

This results in guide recesses 50 adjacent to a guide projection 43 axially on the inside, as well as adjacent to a counter-guide projection 44 axially on the outside, into which the guide projections 43 or the counter-guide projections 43 of the other tool part move in the course of the tool parts 6 and 7 moving together.

In particular, the guide projections can also be provided in a point-symmetrical arrangement.

In the event that four guide projections are provided on the same tool part, they are each arranged opposite one another on the narrow side with respect to the receiving space.

By the guide projections moving in, it is in particular possible to ensure an exact alignment of the tool parts to one another, in the longitudinal direction and in the circumferential direction.

FIGS. 4b and 4c show alternative configurations in which the guide projections 43 and counter-guide projections 44 are formed on the further blades 20 or 20′ that can be arranged at the ends viewed in the direction of the longitudinal dimension a. Each blade 20 or 20′ preferably has a guide projection 43 and a counter-guide projection 44, wherein here too, the counter-guide projection 44 is arranged offset with respect to the guide projection 43 in the direction of the longitudinal dimension a by the thickness dimension f, and guide recesses 50 for the guide projection of the opposite further blade are created axially on the inside of the guide projection 43 and axially on the outside of the counter-guide projection 44.

The guide projections preferably provide the guiding recess both in the circumferential direction of the cable to be stripped and in a longitudinal direction, so that in the case of, for example, a helical cut extending circumferentially in the insulating wall, there are no offsets or at least no offsets in the course of the cut that impair removal of the cut-in insulating wall portion.

The foregoing explanations serve to illustrate the inventions covered by the application as a whole, which refine the prior art at least by means of the following combinations of features also independently in each case, wherein two, more or all of these combinations of features can also be combined, namely:

A first and a second tool part 6, 7, which can be mounted exchangeably in tool jaws 4, 5 of a hand-held tool 1 and can be moved together by the tool jaws 4, 5, for enclosing a cable 8, wherein the cable 8 has a cable core 9 and an insulating sheath 10, wherein each tool part 6, 7 has a body which forms a receiving region and is formed to enclose a region of the cable 8 which is semicircular in cross-section, wherein the receiving region 13 has a longitudinal dimension a and a transverse dimension b, wherein further the receiving region 13 has a plurality of blades 15, wherein each blade 15 has a blade tip 16 and the blade tips 16 delimit a clearance in which it is intended to receive the cable core 9, and wherein further the blade tips 16, when the tool parts 6, 7 are moved together, extend in such a manner that they form a helical line 18.

First and second tool parts, wherein each tool part 6, 7 further has a further blade 20, 20′ provided at least at one end of the receiving region 13, wherein the further blade 20, 20′ extends in a direction of the transverse dimension b of the receiving region 13.

First and second tool parts, wherein two further blades 20 are provided on each of the two tool parts 6, 7.

First and second tool parts, characterized in that the helical line is of multi-start design.

First and second tool parts, characterized in that different types of further blades 20, 20′ are provided.

First and second tool parts, wherein a further blade 20, 20′ is provided as a stripping blade AS which does not extend or does not extend substantially into the cable core.

First and second tool parts, wherein a further blade is provided as a separating blade, which extends into the cable core 9 and serves to separate the cable 8.

First and second tool parts, which can be mounted exchangeably in tool jaws 4, 5 of a hand-held tool 1 and can be moved together by the tool jaws 4, 5, for enclosing a cable 8 which has a cable core 9 enclosed by an insulating sheath 10, each tool part 6, 7 having:
a body forming a receiving region 13, wherein the receiving region 13 is formed to enclose a semi-circular region of the cable 8, wherein the receiving region 13 has a longitudinal dimension a and a transverse dimension b;
a plurality of separate blades 24 extending longitudinally in the receiving region 13, wherein a bottom region 29 of the receiving region 13 extends along the longitudinal dimension a and has a transverse dimension c between the longitudinally extending blades 24, wherein, in a cross-section, a depth dimension d of the receiving region 13 is greater than the transverse dimension C;
transverse blades 26, which form ends of the receiving region 13; and an ejection part M which acts on a portion 11 of the insulating sheath within the receiving region 13.

A first and a second tool part, characterized in that the ejection part M is a spring element 38 arranged in the bottom region 29 of each tool part 6, 7, wherein the spring element 38 is elastically deformable by a portion 11 of the insulating sheath 10.

A first and second tool part, characterized in that the spring element 38 is a leaf spring 40.

A first and a second tool part, characterized in that the spring element 38 is an elastically restorable plastic part 39.

A first and second tool part, characterized in that an undeformed cross-section of the elastically restorable plastic part 39 is a circle.

A first and a second tool part, characterized in that the ejection part M is a deformation part 36 projecting from the bottom region 29 of each tool part 6, 7 and protruding into the receiving region 13 of each tool part 6, 7.

A first and second tool part, characterized in that at least one of the longitudinally extending blades 24 and the transverse blades 26 of each tool part 6, 7 is formed in multiple parts so that a connecting web 32, 42 between insulating portions 11 of the insulating sheath 10 or an insulating portion 11 of the insulating sheath 10 and another part of the insulating sheath 10 remain after a cutting process.

A first and a second tool part, wherein each tool part 6, 7 further has a through-opening 34 extending between an outer surface 33 of the body and the bottom region 29 of the receiving region 13, wherein the through-opening 34 is formed to receive a pushing element 35 which is able to act on a portion of the insulating sheath 10 in the receiving region 13.

A first and a second tool part, wherein each tool part 6, 7 has at least two guide projections 43, 44 spaced apart from each other along the longitudinal dimension a of the receiving region 13 and projecting in a direction in which they move together, wherein the two guide projections 43, 44 are exposed in an open position of the tool parts 6, 7, and each tool part 6, 7 further has guide recesses 57 which receive a respective guide projection 43, 44 when the tool parts 6, 7 are moved together.

A first and a second tool part, characterized in that two guide protrusions 43, 44 of the same tool part 6, 7 are formed such that they oppose each other with respect to the receiving region 13.

A first and a second tool part, characterized in that each tool part 6, 7 has three or four guide projections 43, 44.

A method of stripping comprising a cable core 9 and an insulating sheath 10, comprising:
moving a first tool part relative to a second tool part 5, 6;
cutting an insulating portion of an insulating sheath 10 of the cable arranged in receiving regions of the first and second tool parts 6, 7 using at least one blade of each of the first and second tool parts 6, 7;
ejecting the portions from the receiving regions using an elastic restoring force of the insulation portions 11 or a spring element 38 arranged in a receiving region of the first and second tool parts 6, 7.

A method of stripping comprising a cable core 9 and an insulating sheath 10, comprising:
moving a first tool part relative to a second tool part 5, 6;
cutting a first insulating portion of an insulating sheath 10 of the cable arranged in receiving regions of the first and second tool parts 6, 7 using at least one blade of each of the first and second tool parts 6, 7, wherein the cutting of the first insulating portion only partially separates the first insulating portion 11 from a second insulating portion 11 or from the remaining insulating sheath so that the tool part 6, 7 can be removed without carrying along the first insulating portion 11, and further comprising:
cutting out the first insulating portion 11 by additional cutting or tearing action.

All features disclosed are (in themselves, but also in combination with each other) pertinent to the invention. The disclosure content of the associated/accompanying priority documents (copy of the prior application) is also hereby included in full in the disclosure of the application, including for the purpose of incorporating features of these documents in claims of the present application. The subsidiary claims, even without the features of a referenced claim, characterize with their features independent inventive refinements of the prior art, in particular to undertake divisional applications based on these claims. The invention specified in each claim may additionally have one or more of the features which are specified in the above description, in particular those provided with reference numerals and/or specified in the reference list. The invention further relates to embodiments in which individual features mentioned in the above description are not implemented, in particular insofar as they are evidently dispensable for the respective intended use or can be replaced by other means that are technically equivalent.

1. A first tool part and a second tool part, which can be mounted exchangeably in tool jaws of a hand-held tool and can be moved together by the tool jaws, for enclosing a cable, wherein the cable has a cable core and an insulating sheath each tool part comprising:
a body which forms a receiving region which encloses a region of the cable which is semicircular in cross-section, the receiving region having a longitudinal dimension and a transverse dimension;
a plurality of blades each blade having a blade tip and the blade tips delimit a clearance in which it is provided to receive the cable core, and wherein further the blade tips, when the tool parts are moved together, extend to form a helical line;
an exchangeable further blade provided at least at one end of the receiving region when viewed in the direction of the longitudinal dimension, forms a boundary at the end of the receiving region, is configured to be fastened at the end, extends in a direction of the transverse dimension of the receiving region, and is provided as a separating blade which extends into the cable core and serves to separate the cable.

2. The first and second tool parts according to claim 1, wherein two further blades are provided on each of the two tool parts.

3. The first and second tool parts according to claim 1, wherein the helical line is of multi-start design.

4. The first and second tool parts according to claim 1, wherein different types of further blades are provided.

5. The first and second tool parts according to claim 1, wherein a further blade is provided as a stripping blade which does not extend or does not extend substantially into the cable core.

6. A first tool part and a second tool part, which can be mounted exchangeably in tool jaws of a hand-held tool and can be moved together by the tool jaws, for enclosing a cable which has a cable core which is enclosed by an insulating sheath, each tool part comprising:
a body forming a receiving region which encloses a semicircular region of the cable, and the receiving region has a longitudinal dimension and a transverse dimension;
a plurality of blades that are separated from each other and extend longitudinally in the receiving region, wherein a bottom region of the receiving region extends along the longitudinal dimension and has a transverse dimension between the longitudinally extending blades, wherein, in a cross-section, a depth dimension of the receiving region is greater than the transverse dimension;
transverse blades which form ends of the receiving region;
an ejection part which can act on a severed portion of the insulating sheath within the receiving region, for detaching from the tool part, wherein the ejection part can act on the portion located in the receiving region in such a manner that any jamming which may occur can be overcome and a detaching from the tool part can thus be achieved, wherein the ejection part is a deformation part which projects from the bottom region of each tool part and protrudes into the receiving region of each tool part.

7. The first and second tool parts according to claim 6, wherein the ejection part is a spring element arranged in the bottom region of each tool part, wherein the spring element is elastically deformable by a portion of the insulating sheath.

8. The first and second tool parts according to claim 7, wherein the spring element is a leaf spring.

9. The first and second tool part according to claim 7, wherein the spring element is an elastically recoverable plastic part.

10. The first and second tool part according to claim 9, wherein an undeformed cross-section of the elastically recoverable plastic part is a circle.

11. The first and second tool parts according claim 6, wherein at least one of the longitudinally extending blades and the transverse blades of each tool part is formed in multiple parts so that a connecting web between insulating sections of the insulating sheath or an insulating section of the insulating sheath and another part of the insulating sheath remain after a cutting operation.

12. The first and second tool parts according to claim 6, wherein the first and second tool parts are received in the tool jaws of the hand-held tool, wherein at least one of the longitudinally extending blades of each tool part is formed in multiple parts so that a connecting web between insulating portions of the insulating sheath or an insulating portion of the insulating sheath and another part of the insulating sheath remain after a cutting process, wherein each tool part further has a through-opening extending between an outer surface of the body and the bottom region of the receiving region, wherein the through-opening is formed to receive a pushing element which can act on a portion of the insulating sheath in the receiving region.

13. The first and second tool parts according to claim 6, wherein each tool part has at least one guide projection and at least one counter-guide projection, which are spaced apart from one another along the longitudinal dimension of the receiving region and project in a direction in which the tool parts move together, wherein the two guide projections are exposed in an open position of the tool parts and each tool part further has guide recesses which receive a respective guide projection when the tool parts are moved together, wherein, in relation to a longitudinal extent in the direction of the longitudinal dimension of the receiving region, the counter-guide projection is arranged offset inwards with respect to the guide projection, wherein a surface of the guide projection pointing outwards in the longitudinal direction extends in a plane of an associated tool part end face.

14. The first and second tool parts according to claim 13, wherein two guide projections of the same tool part are formed so as to be opposite with respect to the receiving region.

15. The first and second tool parts according to claim 13, wherein each tool part has three or four guide projections.

16. A method for stripping a cable having a cable core and an insulating sheath, comprising:
moving a first tool part relative to a second tool part;
cutting an insulating portion of the insulating sheath of the cable which is arranged in receiving regions of the first and second tool parts, using at least one blade of each of the first and second tool parts; and
ejecting the insulating portion from the receiving regions using a spring element which is arranged in a receiving region of the first and second tool parts, wherein the spring element acts on the insulating portion located in the receiving region in such a manner that any jamming which may occur is overcome and a detaching from the tool part is thus achieved.

17. The method according to claim 16, comprising:
moving the first tool part relative to the second tool part;
cutting an insulating portion of the insulating sheath of the cable arranged in receiving regions of the first and second tool parts, using at least one blade of each of the first and second tool parts; and
ejecting the insulating portion from the receiving regions using a through-opening of one of the tool parts, which through-opening extends between an outer surface of a body of the tool part forming the receiving region and a bottom region of the receiving region, wherein the through-opening receives a pushing element which acts on a portion of the insulating sheath in the receiving region.

18. The first and second tool parts according to claim 14, wherein each tool part has three or four guide projections.
